(19) United States
(12) Patent Application Publication
(10) Pub. No.: US 2007/0081222 A1
(43) Pub. Date: Apr. 12, 2007

(54) Adjustable pinhole for a laser-scanning microscope

(76) Inventors: Karlheinz Bartzke, Gotha (DE); Ralf Wolleschensky, Apolda (DE)

Correspondence Address: JACOBSON HOLMAN PLLC, 400 SEVENTH STREET N.W., SUITE 600, WASHINGTON, DC, 20004, US

(21) Appl. No.: 10/557,696

(22) PCT Filed: May 12, 2004
(86) PCT No.: PCT/EP04/05061

§ 371 Date: Nov. 22, 2005

(30) Foreign Application Priority Data
May 22, 2003 (DE) 103 23 923.5

(51) Int. Cl. G02B 26/02

(52) U.S. Cl. 359/233

(57) ABSTRACT

An adjustable pinhole for a laser scanning microscope. The adjustable pinhole includes first and second silicon apertures movable relative to each other, each of the silicon apertures having a rectangular mirror-inverted opening, the relative movement of the openings defining a pinhole of varying size. The relative movement can be in two directions, whereby the first and second silicon apertures are displaceable with respect to one another in a first direction and whereby at least one of the silicon apertures is displaceable in a second direction perpendicular to the first direction for adjustment to obtain an exact square form for the configuration of the pinhole.

### BACKGROUND OF THE INVENTION

1. Field of The Invention

The present invention relates to laser scanning microscopes and to adjustable pinholes for use therein.

1. Description of Related Art

The geometrical parameters of the pinhole are critical to the efficiency of a laser scanning microscope. The smaller the pinholes are and the more precisely they can be adjusted, the higher the resolutions of the laser scanning microscope that can be achieved and, accordingly the smaller the dimensions of the microscope optics that are possible. It is advantageous, if the pinhole apertures can be adjusted to sizes of about 3 μm or greater. In this case, the reproducibility of 0.3 μm in the adjustment of the pinhole aperture and position is essential. Still smaller pinhole apertures lead to high intensity losses due to diffraction of the light passing through the edge area of the pinhole. The pinhole aperture, which is mainly arranged in front of a photo-receiver, need not be circular but can also have a square form.

To accomplish adjustable pinholes in laser scanning microscopes, elements are used, which have, preferably in order to give a square aperture, adjustable straight edges. In order that these physical edges are as sharp as possible and the aperture has a slight extension in the direction of the light flux, these elements are either fastened at the edges of the aperture or the elements are thin foils. The state-of-the-art of finishing technology enables the making of edges that have pinholes with an extension greater than 10 μm in the direction of the light flux. However, in such pinholes, there is the danger of vignetting of the light, if the size of the aperture is to be adjusted to less than 10 μm.

Thus, in DE 202 05 079 U1, a variable pinhole for a confocal scanning microscope is described, which consists of two diametrically movable aperture claws with grooves. This type of groove can be produced with sharp edges only to a limited extent; therefore such pinholes have an extension of about 100 μm in the direction of the light flux. The disadvantages of this solution lie in the danger of the vignetting of the light and the unavoidable curves at the corners in the grooves. Both lead to the conclusion that the square-shaped apertures cannot be adjusted to sizes smaller than 10 μm. Sufficiently small oblique positioning of the pinhole, with less than 0.1°, for instance, can be achieved only with relatively high technical expense.

An object of the present invention is to realize an adjustable pinhole, which enables apertures with sizes greater than 3 μm in a field of 1×1 mm² with the tolerance of 0.3 μm. Thereby, it is important to keep the physical dimensions of the aperture in the direction of the light flux as small as possible, for example smaller than 10 μm, in order to avoid the vignetting of the light passing through the aperture.

### BRIEF SUMMARY OF THE INVENTION

The proposed solution lies in using two mirror-inverted and mutually displaceably arranged silicon apertures for the pinhole in the laser scanning microscope, each with a square etched window.

The advantage of the solution lies in that silicon has a cubic crystalline structure, and therefore square apertures, whose edges are atomically sharp-edged, are generated in the photolithographic etching. Furthermore, the flanks of the aperture exhibit an acute-angled etching angle of 54.7°, so that the mirror-inverted arrangement of two silicon aperture pinholes, with arbitrarily small openings and arbitrarily small extent in the direction of the light flux, can be built.

A further advantage lies in that, with silicon as the material for the aperture, optically soft apertures are built within a certain visual spectral range of about 500 nm, because silicon is increasingly transparent to light with increasing wavelength in that spectral range. As a result, within this limited wavelength range of about 500 nm, diffraction effects at the aperture can be avoided or reduced. This leads to a reduction in the loss of light in the laser scanning microscope due to diffraction and to higher light intensities on the photo-receiver for small pinhole apertures and hence to greater sensitivity of the laser scanning microscope in this spectral range of light.

The disadvantage of silicon, namely its increasing light transparency in the region of visual red and onwards, can be eliminated by means of a reflection or an absorption coating on its surface.

In silicon plates with outside dimensions of about 7×5×0.5 mm², windows of size 1×1 mm² are etched photolithographically. The silicon apertures are arranged mutually pairwise, so that the etched windows lie mutually mirror-inverted. The fastening of the silicon apertures on the mechanical contrivance of the pinhole is done by gluing. A distance plate serves the purpose of retaining the necessary distance between the upper aperture and the mechanical contrivance of the pinhole. A spacer foil, which is arranged between the apertures, enables achievement of a pinhole height of 10 μm. By means of an anti-parallel movement of both the elements of the mechanical contrivance of the pinhole, the pinhole size can be adjusted between 0 and 1 mm.

The direction of the movement of the mechanical contrivance of the pinhole is thereby anti-parallel to the diagonal of the etching window in the silicon plate.

A protective coating is provided on the Silicon (Si) aperture in order to hinder the passage of the light through the aperture outside the opening because silicon is increasingly transparent to light with higher wavelength for wavelengths greater than 500 nm. For this, a layer of chromium, gold, aluminum or silver of about 100 nm thickness can be vapor deposited on the silicon apertures. All these layers have, however, the disadvantage of high reflectivity, so that interfering stray light scattered due to the reflection is generated in the laser scanning microscope.

More suitable are black light absorbing protective layers, such as those that can be coated, for example, by means of special vapor deposition. Contrary to expectations, one can also work without the coating, which is advantageous in wavelength range up to 600 nm.

For justification, the adjustment of the openings with a small aperture, for example with a size of 10 μm, is done under a microscope by means of manipulators. Since, due to the small height of the pinhole, a depth of field of only 10 μm is necessary for the microscope, it is possible to use high resolution microscopes with an aperture of, for example, A=0.8. In the common types of pinholes, this is not possible because the microscope must have, due to the pinhole height of 100 μm, a correspondingly high depth of field, and a small aperture of, for instance, A=0.1.

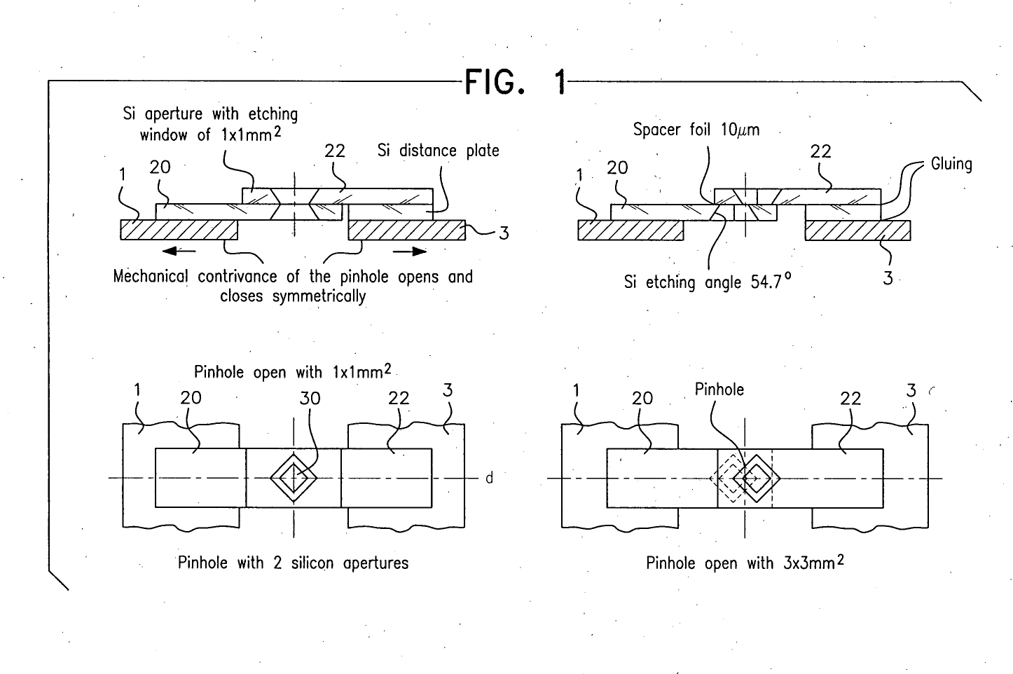

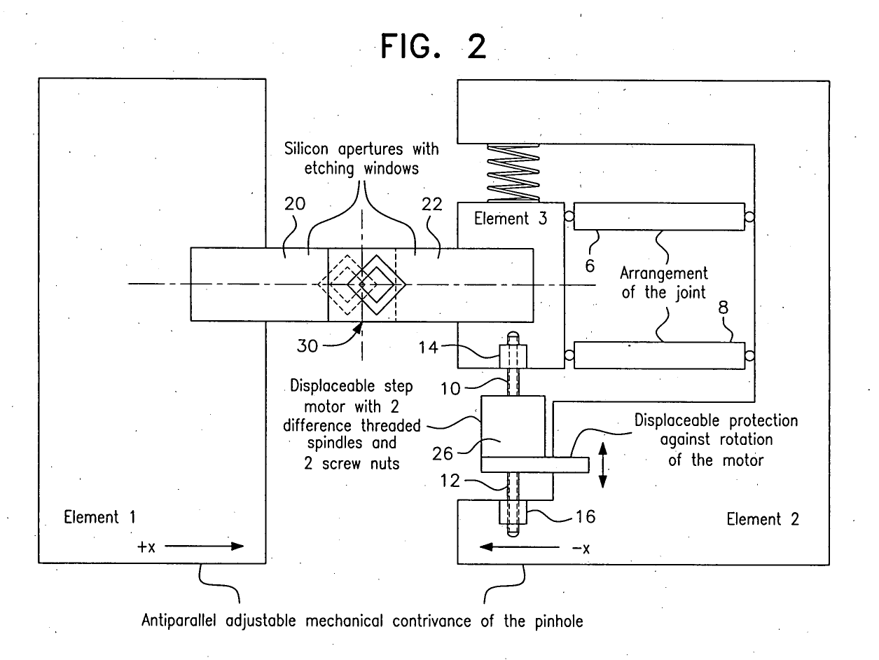

As shown in FIG. 2, elements 1 and 2 are displaceable anti-parallel in the x-direction and support both of the silicon apertures, whereby at least one aperture is supported on another element 3, which is displaceable perpendicular to the direction of the displacement of elements 1 and 2.

Element 3 is fixed on two flexible solid joints 6,8, which exhibit high rigidity in the direction of the displacement of the elements 1 and 2 and exhibit high flexibility in the direction of the displacement of the element 3.

The displacement of element 3 in the y-direction takes place by means of two spindles driven by a motor, whereby the motor is arranged in a rotation-proof and displaceable manner on element 2. The two spindles 10,12, each one of which grips a screw nut 14,16, respectively, fastened on elements 2 and 3, exhibit slopes that are advantageously different. For example, there can be a slope difference of 50 μm.

The silicon apertures 20,22 are glued in a pre-justifiable position on the elements 1 and 3 of the mechanical contrivance of the pinhole (FIG. 2). Due to the motor drive with difference threaded spindles acting between elements 1 and 3 in the y-direction, and due to the arrangement of the joints (for example, solid parallel spring joint), the justification, as well as the later readjustment of the silicon apertures with resolutions of, for example, 0.1 μm, is possible in the laser scanning microscope at any time. The resolution of 0.1 μm follows from the slope difference of the threaded spindles of, for instance, 50 μm, from the micro-step operation of the stepmotor 26 with 16 micro-steps per full step and from 20 full steps per motor revolution. In the justification, the elements 1 and 2 are adjusted anti-parallel to the x-direction, and the element 3 is adjusted in the y-direction by means of the motor 26 until a square pinhole 30 of, for instance, 10×10 mm² is formed. The pinhole aperture is now square with that size, as it will be for other sizes, if the elements 1 and 2 are displaced anti-parallel in the x-direction. The advantage is that, in this manner the pinhole of the laser scanning microscope can also be readjusted afterwards anytime, if its microscopic observation there is possible. The elements 1 and 2 are moved anti-parallel in the x-direction for the adjustment of the pinhole size by means of a scissors-like mechanism not shown here.

The pinhole 30 can be adjusted to a square form in the laser microscope at any time, even without its microscopic observation, solely on the basis of the evaluation of the photo-receiver signals of the laser scanning microscope. For this purpose, the elements 1, 2 and 3 are adjusted by means of a motor-driven scanning process in such a manner that, with the pinhole aperture 30 as small as possible, the light falling on the photo-receiver has the maximum intensity. In that case, the pinhole must have a square form. For this purpose, with the stepwise reduction in the size of the opening of the aperture (x-drive), the Si aperture 22 on the element 3 is adjusted by means of the y-drive in such a manner that the photo-receiver receives the maximum light signal. This scanning process is repeated alternately with the x- and y-drives, until the maximum light signal of the photo-receiver reaches a predetermined minimal value, which corresponds to the pinhole size of, for instance, 10 μm. Following this automatic justification process, the pinhole aperture has necessarily a square form for all sizes.

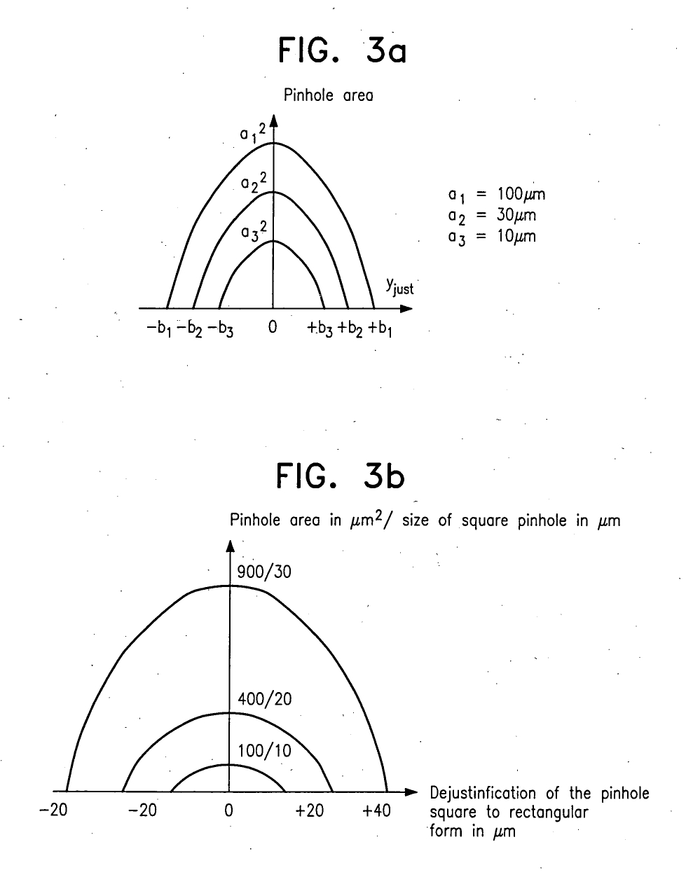

As can be seen from the family of curves in FIG. 3a, due to the quadratic dependence of the pinhole area with respect to the pinhole dejustification for yⱼᵤₛₜ=0, one obtains a very low sensitivity of the photo-receiver with respect to the adjustment in the y-direction and the dejustification at yⱼᵤₛₜ=b. Therefore, the flank method, in which, during the scanning in the y-direction, on each of the two symmetrical flanks, one measurement point is determined with high sensitivity and the square pinhole form is obtained by adjusting to the average value for the two flanks, can be employed here advantageously.

This justification is initiated with a relatively large pinhole aperture of, for example, 100 μm, and is concluded with a pinhole size that is as small as possible, for example, 10 μm. The result for all pinhole sizes is necessarily a square pinhole aperture. Exemplary values are given in FIG. 3b.

1. An adjustable pinhole for a laser scanning microscope, the adjustable pinhole comprising:
first and second silicon apertures movable relative to each other, each of said silicon apertures having a rectangular mirror-inverted opening, the relative movement of the apertures defining a pinhole of varying size.

2. The adjustable pinhole according to claim 1, whereby the first and second silicon apertures are displaceable with respect to one another in a first direction.

3. The adjustable pinhole according to claim 2, whereby at least one of said silicon apertures is displaceable in a second direction perpendicular to the first direction for adjustment to obtain an exact square form for the configuration of the pinhole.

4. The adjustable pinhole according to claim 3, whereby the apertures are fastened on flexible solid joints, which are arranged in a rigid manner in the first direction and are flexible in the second direction.

5. A method for adjustment of a pinhole in a laser scanning microscope having a photo-receiver, the method comprising the steps of:
forming a square-shaped pinhole from first and second silicon apertures, each one with a rectangular mirror-inverted opening;
passing light through the pinhole; and
moving the apertures to maximize the light received by the photo-receiver.
